(19) United States
(12) Patent Application Publication
(10) Pub. No.: US 2013/0276269 A1
(43) Pub. Date: Oct. 24, 2013

(54) BELT BUCKLE STRUCTURE

(71) Applicant: Yung-Fa SU, Kaohsiung City (TW)

(72) Inventor: Yung-Fa SU, Kaohsiung City (TW)

(21) Appl. No.: 13/594,670

(22) Filed: Aug. 24, 2012

(30) Foreign Application Priority Data
Apr. 23, 2012 (TW) 101114339

(51) Int. Cl. H01F 7/02

(52) U.S. Cl. 24/303

(57) ABSTRACT

A belt buckle structure includes a buckle and a circular element. The buckle has a surface with a recess formed thereon. A first step surface and a second step surface in the recess are formed at different elevations. The second step surface is at a higher elevation and has a first positioning magnet and a second positioning magnet located thereon. The circular element slides clockwise or counterclockwise to be positioned at a desired location in the recess, and can be removed or positioned as desired whenever needed by users. Thus the functionality of the belt can be increased, and the difficulty of positioning the graphic on the top surface of the circular element in the correct alignment can be resolved.

### FIELD OF THE INVENTION

The present invention relates to a belt buckle structure, particularly to a belt buckle having a recess which facilitates correct alignment and easy removing of a circular element.

### BACKGROUND OF THE INVENTION

A conventional belt 1, referring to FIG. 1, generally includes a strap 11 with one end fastened to a belt buckle 12. The strap 11 has other end which can be threaded through the belt buckle 12 for anchoring. While the belt 1 thus formed can hold a user's pants without dropping, it provides no other function. Belt producers have tried numerous ways, such as changing the material of the strap 11, fastening schemes or profiles of the belt buckle 12, and adding more functions for the belt 1, to whet the purchase desire of consumers, and some belt producers also try to print patterns on the end surface of the belt buckle 12 to enhance appeal or serve as emblems of the producers, thereby to change the structure of the belt 1 and enhance its functionality.

In view of the aforesaid considerations, Applicant has provided improvements of belt buckle that are disclosed in R.O.C. patent Nos. I302445 and I329499. In I329499 the belt buckle has a circular element on the surface with a magnet located thereon for attraction and positioning. However, positioning of the circular element on the correct location is quite difficult, and the graphic on the top surface of the circular element is easily skewed and not aligned accurately. It could happen that the circular element has to be removed repeatedly to align the graphic correctly before the desired positioning is made. As a result, its usability suffers and correct alignment of the graphic on the circular element is difficult.

The aforesaid disadvantages not only cause user's inconvenience, also reduce user's desire for buying the belt products. To provide an improved belt without the aforesaid problems and allowing the circular element to be removed for other use whenever needed and aligned correctly and attracted and positioned at a desired location on the belt buckle is goal yet to be fulfilled.

### SUMMARY OF THE INVENTION

The primary object of the present invention is to solve the problem of the conventional belt buckle that is difficult to correctly position the circular element after being attracted to the top surface of the graphic and has to be removed and repositioned for correct mounting. The present invention provides a belt buckle that allows a circular element aligned correctly and positioned at a desired location and removed whenever needed, and also can align a graphic layer of the circular element correctly.

To achieve the foregoing object the belt buckle according to the invention includes a buckle and a circular element. The buckle has a top surface with a recess formed thereon. A first step surface and a second step surface in the recess formed at different elevations. The second step surface is at a higher elevation and has a first positioning magnet and a second positioning magnet located thereon. The first positioning magnet is formed in a strip shape and located in the center of the recess. The second positioning magnet is a strut and adjacent to the first positioning magnet. The circular element has a bottom surface with a first magnet embedded in the center and a second magnet adjacent to the first magnet. The first magnet and second magnet are formed respectively in the same shapes as the first and second positioning magnets, and attracted magnetically to each other so that the circular element slides clockwise or counterclockwise to make correct alignment for a graphic layer on the top surface and be attracted and positioned onto the buckle. The circular element can be removed freely through the first step surface formed at a lower elevation so that users can take the circular element for other use as required, thereby improve the functionality of the belt.

Through the structure of the belt buckle set forth above, the second step surface is formed at an elevation higher than the first step surface, and the second step surface also can have a circular first positioning magnet in the center of the recess and a circular second positioning magnet adjacent to the circular first positioning magnet, or a first positioning magnet and a second positioning magnet formed in circular and located in the center of the recess in a juxtaposed manner that are in different magnetic polarities of positive polarity and negative polarity, thereby to attract respectively a first magnet of negative polarity and a second magnet of positive polarity at the bottom surface of the circular element that are formed in the same shapes and at the same locations, hence the circular element can be aligned correctly and attracted and positioned at the desired position, and also can be removed freely or positioned as desired so that users can remove the circular element for other use whenever required.

Compared with the conventional techniques, the present invention provides many advantages, notably:

1. The surface of the buckle and the bottom surface of the circular element have respectively first and second positioning magnets and first and second magnets with corresponding magnetism and same locations and shapes, thereby the circular element can slide clockwise or counterclockwise for correct alignment and be positioned at the desired position on the recess of the buckle.

2. The first and second positioning magnets on the surface of the buckle are formed in different polarities of positive and negative polarities, and the first and second magnets at the bottom surface of the circular element are formed respectively in negative polarity and positive polarity corresponding to the first and second positioning magnets to attraction each other, thereby users can easily and quickly position the circular element according to the graphic layer on the top surface without the trouble of fumbling for the correct alignment.

3. The invention can increase the appeal of the belt buckle and consumer's buying desire.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional belt.

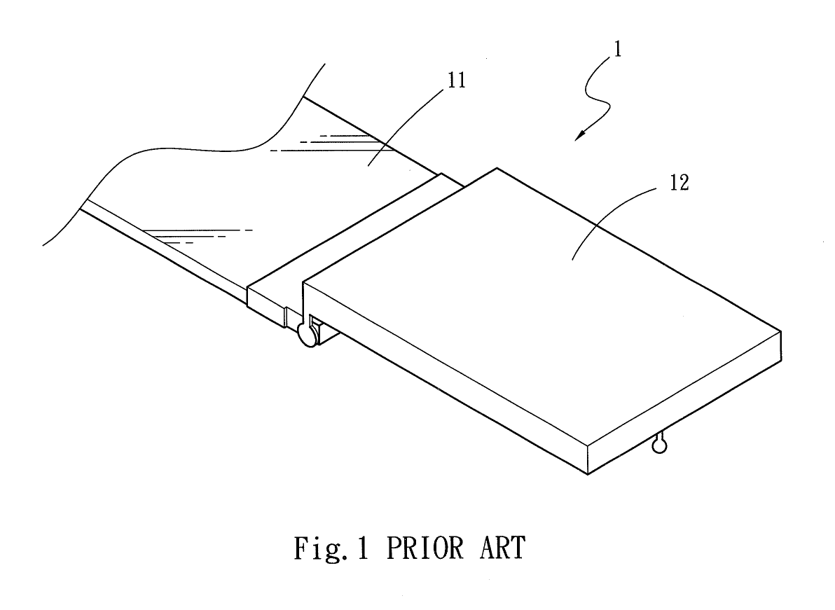

FIG. 2 is an exploded view of an embodiment of the belt buckle of the invention.

FIG. 3 is an exploded view of the buckle and circular element according to FIG. 2.

FIG. 4 is a sectional view according to FIG. 2 in an assembled condition.

FIG. 5 is a top view of the graphic layer of the circular element according to FIG. 2.

FIG. 6 is a schematic view of the removed circular element according to FIG. 2.

FIG. 7 is a schematic view of the circular element according to FIG. 2 in an aligning condition.

FIG. 8 is an exploded view of the first embodiment of the invention.

FIG. 9 is a schematic view of the circular element according to FIG. 8 in an aligning condition.

FIG. 10 is an exploded view of second embodiment of the invention.

FIG. 11 is a schematic view of the circular element according to FIG. 10 in an aligning condition.

### DETAILED DESCRIPTION OF THE PREFERRED EMBODIMENTS

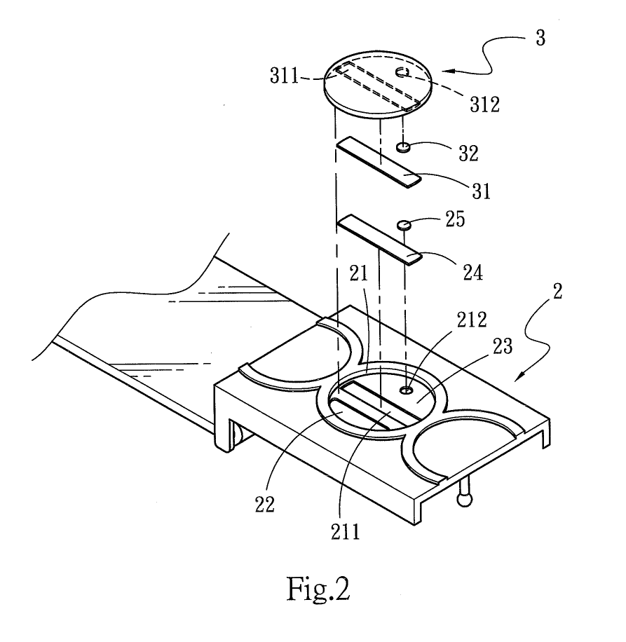

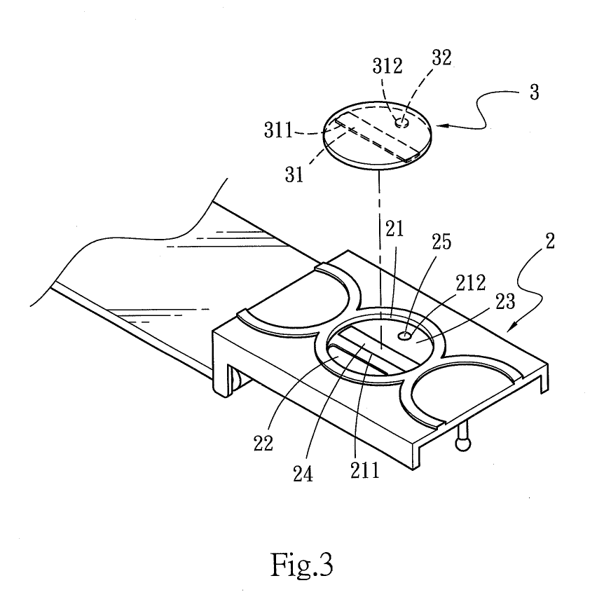

Please refer to FIGS. 2, 3 and 4 for an embodiment of the belt buckle structure of the invention. It comprises a buckle 2 and a circular element 3.

The buckle 2 has a surface with a recess 21 formed thereon. In the recess 21 there are a first step surface 22 and a second step surface 23 formed at different elevations. The second step surface 23 is at a higher elevation than the first step surface 22 and has a first concave 211 in the center of the recess 21. In this embodiment the first concave 211 is formed in a strip shape to hold a first positioning magnet 24 which is positive in polarity and also formed in a strip shape. On the second step surface 23 there is a first circular cavity 212 formed at a position adjacent to the first concave 211. In this embodiment the first circular cavity 212 is formed in a strut shape to hold a second positioning magnet 25 which is negative in polarity and formed in a strut shape.

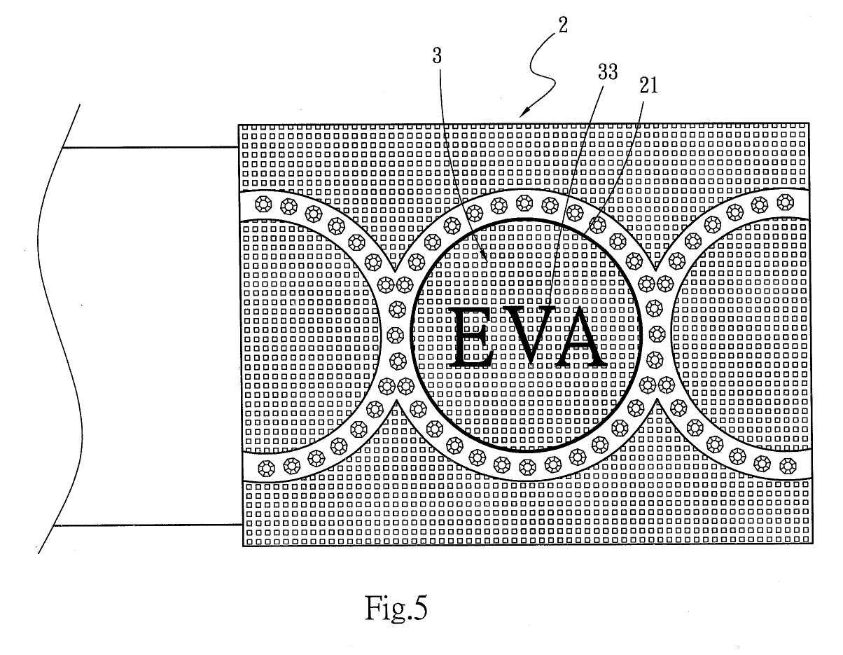

The circular element 3 has a bottom surface with a second concave 311 and a second circular cavity 312 formed thereon that correspond respectively to the first positioning magnet 24 and second positioning magnet 25 in shapes and locations. The second concave 311 holds a first magnet 31, and the second circular cavity 312 holds a second magnet 32. In this embodiment the first magnet 31 is negative in polarity and formed in a strip shape corresponding to the positive first positioning magnet 24 to attract each other. The second magnet 32 is positive in polarity and formed in a strut shape corresponding to the negative second positioning magnet 25 to attract each other. Thus the circular element 3 can move to make correct alignment and be attracted and positioned on the recess 21 of the buckle 2. The circular element 3 also has a graphic layer 33 (referring to FIG. 5) which can be printed or bonded with patterns or characters.

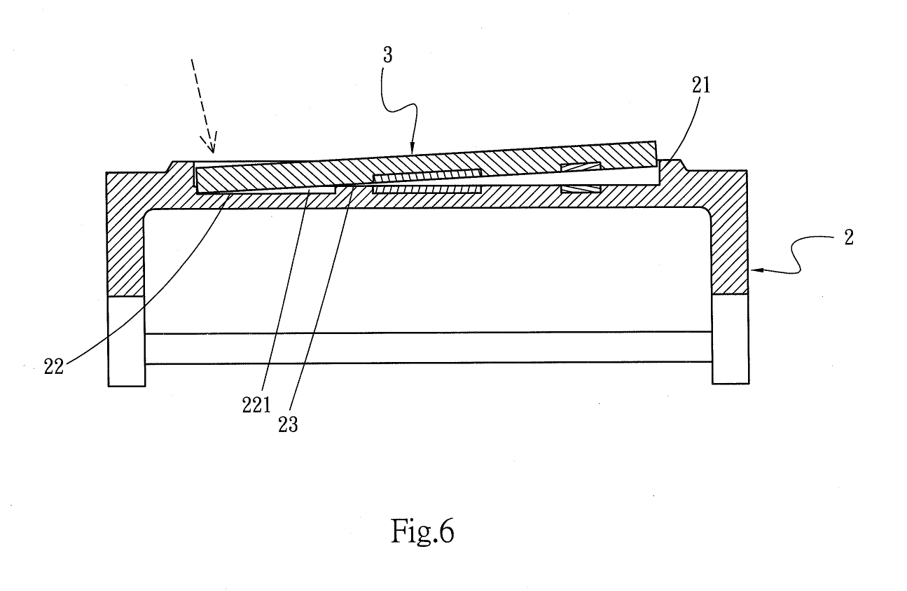

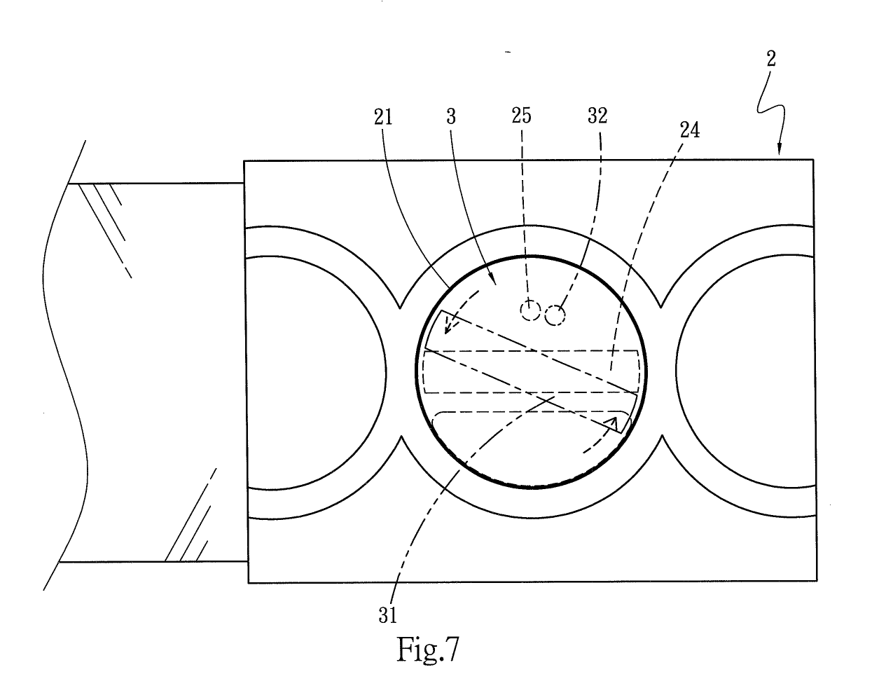

Since the first and second step surfaces 22 and 23 formed in the recess 21 are at different elevations, when the circular element 3 is attracted to the recess 21 and positioned, referring to FIG. 6, one half of the bottom side is in contact with the second step surface 23 of the higher elevation, while another half is suspended over the first step surface 22 of the lower elevation to form a suspended side 221. Hence press the circular element 3 at the suspended side 221, the circular element 3 sinks with the suspended side 211 so that other side of the circular element 3 is tilted upwards, thereby the circular element 3 can be removed easily from the recess 21 for other uses, such as serving as a mark of a golf ball on the green during playing golf to prevent hindering of putting of other golfers to substitute a coin that is generally used now; or a token inserting into a chained shopping cart for releasing without relying on a coin that might otherwise needed. Due to the circular element 3 is flat and circular, when it is placed into the recess 21 correct alignment of the graphic layer 33 on the top surface could be difficult. In the invention the first and second positioning magnets 24 and 25 are set in different magnetic polarities of positive and negative that attract respectively the corresponding first magnet 31 in negative polarity and second magnet 32 in positive polarity, thereby correct alignment and positioning of the graphic layer 33 of the circular element 3 is easier (also referring to FIG. 7). In addition, after the circular element 3 has been removed from the recess 21 it can serve as a substitute of a coin for other uses. The graphic layer 33 on the top surface (referring to FIG. 5) also enhances the appeal or can function as an icon of an institution, and a substitute of a coin. Hence users can have a flat and circular article ready for use whenever needed.

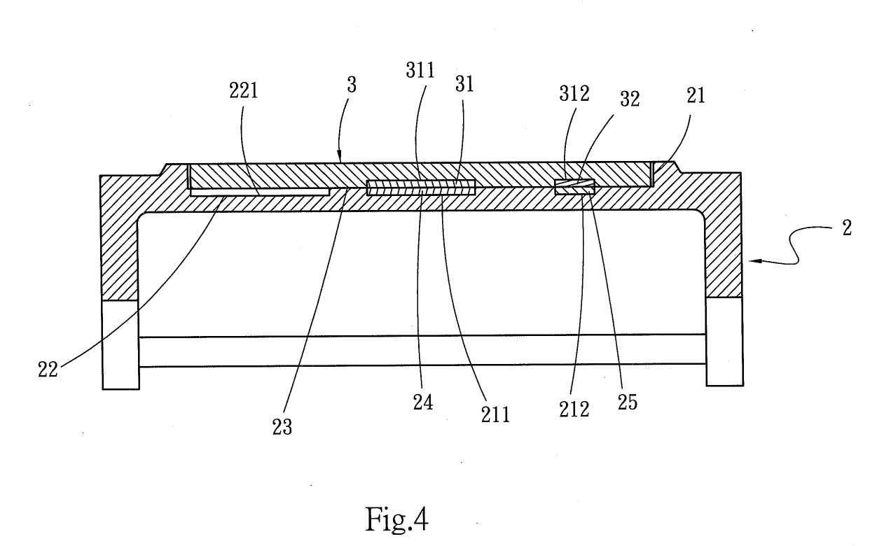

In practice, referring to FIGS. 4 and 7, the positive first positioning magnet 24 and the negative second positioning magnet 25 above the first positioning magnet 24 are located on the higher second step surface 23 of the buckle 2, when the circular element 3 is placed in the recess 21 the corresponding negative first magnet 31 and positive magnet 32 located on the bottom surface thereof are attracted magnetically, hence the circular element 3 can slide clockwise and counterclockwise to make correct alignment and be attracted and positioned at a desired location in the recess 21, and the graphic layer 33 on the top surface of the circular element 3 also can be positioned at the correct location and direction (referring to FIG. 5). Even if incidental impact takes place and the circular element 3 is skewed in the recess 21, realignment is easier. Hence the invention not only can improve positioning of the circular element 3, also make correct alignment of the graphic layer 33 on the circular element 3 easier without skewing.

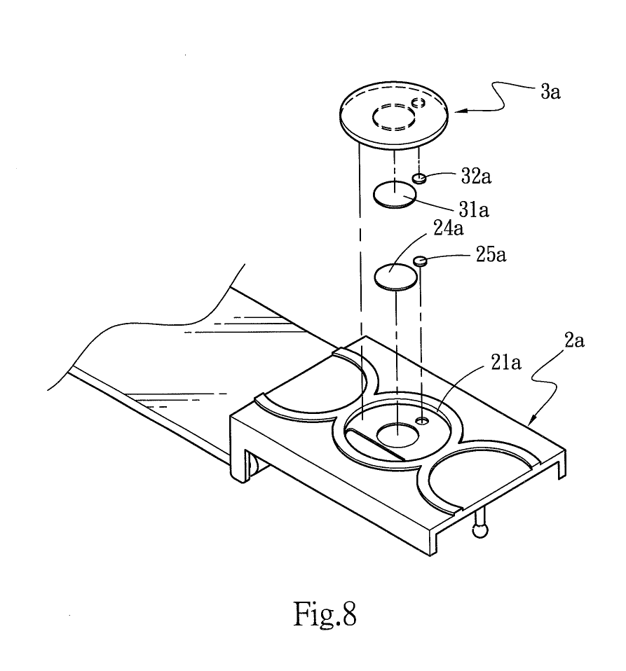

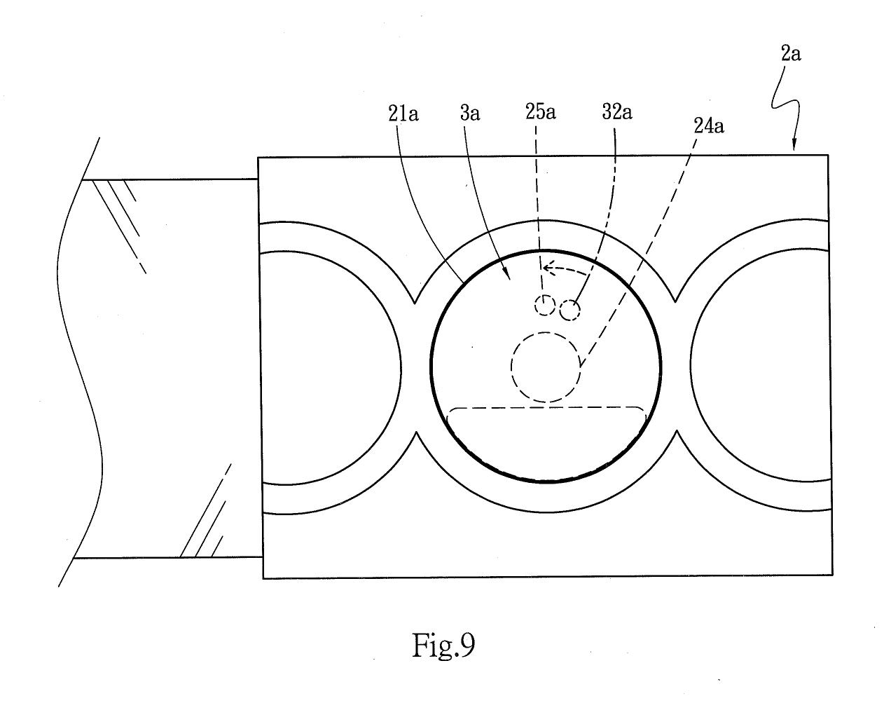

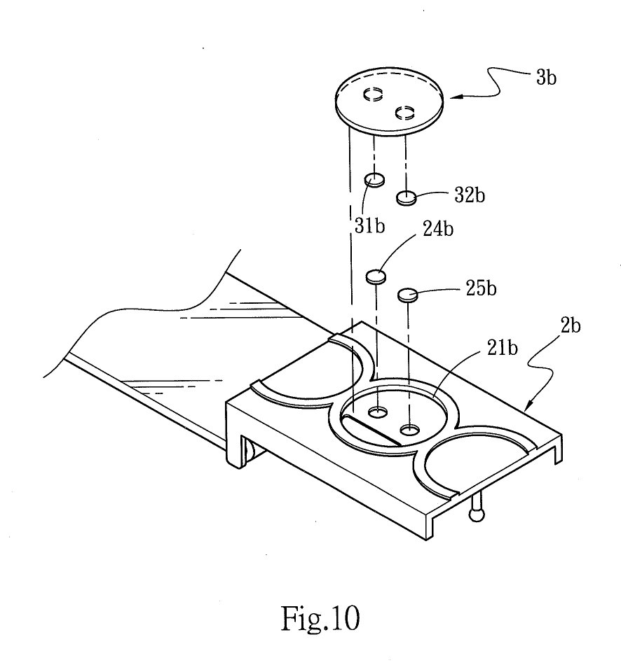

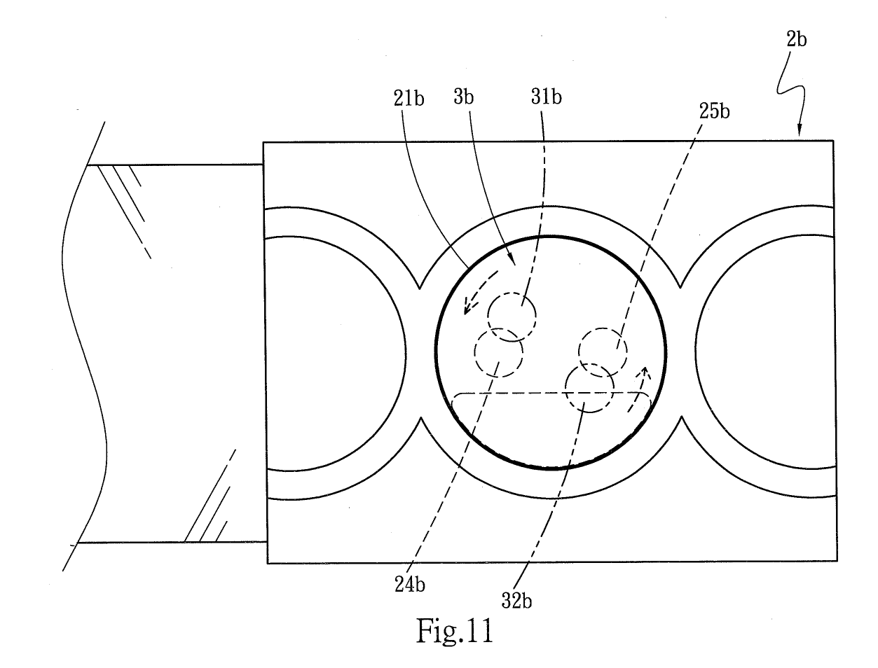

Please refer to FIG. 8 for the first embodiment of the invention. The recess 21a of the buckle 2a holds a positive and circular first positioning magnet 24a in the center, and a negative and circular second positioning magnet 25a adjacent to the first positioning magnet 24a. FIG. 10 depicts the second embodiment in which the recess 21b of the buckle 2b holds a positive and circular first positioning magnet 24b and a negative and circular second positioning magnet 25b in the center that are positioned in a juxtaposed manner. The circular elements 3a and 3b have respectively on the bottom surface a negative magnet 31a and 31b, and a positive magnet 32a and 32b that are formed at the same positions and shapes corresponding to the aforesaid first positioning magnets 24a and 24b, and second positioning magnets 25a and 25b to attract each other. Thereby, when the circular elements 3a and 3b are placed in the recesses 21a and 21b of the buckles 2a and 2b, the circular elements 3a and 3b can slide automatically (as shown by the arrows in FIGS. 9 and 11) to form correct alignment and be positioned as desired via mutual attraction, the graphic layer (not shown in the drawings) on the top surface of the circular elements 3a and 3b also can be positioned and directed correctly.

As a conclusion, the buckle and circular element provided by the invention can be formed in two different or same shapes with corresponding magnetism to attract each other, hence the circular element or a different substitute can be aligned, attracted and positioned correctly on the buckle, and resolve the problem of the conventional belt buckles that can only form attraction but cannot align and position correctly. Thus the invention greatly improves usability and practicality of the belt buckle, enhances the functionality, and has greater appeal to users for buying.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A belt buckle structure, comprising:
a buckle including a recess on a surface, a first step surface and a second step surface of different elevations in the recess, the second step surface being formed at a higher elevation than the first step surface with a first positioning magnet and a second positioning magnet disposed on the second step surface; and
a circular element located in the recess and including a bottom surface with a first magnet and a second magnet disposed thereon, wherein the first magnet corresponds to and attracts the first positioning magnet and the second magnet corresponds to and attracts the second positioning magnet, whereby the circular element secures in the recess of the buckle in correct alignment.

2. The belt buckle structure of claim 1, wherein the second step surface is formed at an elevation higher than the first step surface and includes a first concave in the center of the recess to hold the first positioning magnet formed in the strip shape, the second step surface including a first circular cavity adjacent to the first concave to hold the second positioning magnet formed in a strut shape.

3. The belt buckle structure of claim 2, wherein the bottom surface of the circular element includes a second concave and a second circular cavity which respectively correspond to the first concave and the first circular cavity, the second concave holding the first magnet formed in a strip shape, the second circular cavity holding the second magnet formed in a strut shape.

4. The belt buckle structure of claim 3, wherein the circular element includes a top surface opposite to the bottom surface and a graphic layer formed on the top surface, wherein the graphic layer includes patterns or characters formed by printing or bonding.

5. The belt buckle structure of claim 2, wherein the first concave holds the first positioning magnet formed in circular, and the first circular cavity holds the second positioning magnet formed in circular.

6. The belt buckle structure of claim 5, wherein the first magnet disposed on the bottom surface of the circular element is circular and corresponds to and attracts the first positioning magnet, and wherein the second magnet adjacent to the first magnet is circular and corresponds to and attracts the second positioning magnet.

7. The belt buckle structure of claim 6, wherein the circular element includes a top surface opposite to the bottom surface and a graphic layer formed on the top surface, wherein the graphic layer includes patterns or characters formed by printing or bonding.

8. The belt buckle structure of claim 1, wherein the second step surface is formed at an elevation higher than the first step surface and holds the first positioning magnet and the second positioning magnet in the center of the recess in a juxtaposed manner, wherein the first and second positioning magnet are formed in circular.

9. The belt buckle structure of claim 8, wherein the first magnet and the second magnet disposed on the bottom surface of the circular element are positioned in a juxtaposed manner, the first and second magnet corresponding to and attracting respectively the first positioning magnet and the second positioning magnet of the same shape.

10. The belt buckle structure of claim 9, wherein the circular element includes a top surface opposite to the bottom surface and a graphic layer formed on the top surface, wherein the graphic layer includes patterns or characters formed by printing or bonding.
